(19) United States
(12) Patent Application Publication
(10) Pub. No.: US 2007/0068682 A1
(43) Pub. Date: Mar. 29, 2007

(54) Impact absorbing composite hoof pad and method

(75) Inventor: Ian H. McKinlay, South Amboy, NJ (US)

Correspondence Address: HAROLD I. MASTELLER, JR., P.O. BOX 302, 3325 GREENWOOD DRIVE, SPRINGTOWN, PA, 18081, US

(73) Assignee: McKinlay Hoof Care L.L.C., South Amboy, NJ (US)

(21) Appl. No.: 11/237,030

(22) Filed: Sep. 28, 2005

(51) Int. Cl. A01L 1/04; A01L 7/02

(52) U.S. Cl. 168/12

(57) ABSTRACT

The present is directed to a combination horseshoe and composite hoof pad that dampens the shock of impact and prevents hoof pad distortion when the hoof strikes the ground. The composite hoof pad includes a retainer member fixed to the hoof and bonded to the horseshoe top surface along the toe portion of the hoof, and a cushion member bonded to the remaining horseshoe top surface and coupled to the retainer member so that the retainer member provides a barrier that prevents the cushion member from distorting when the hoof strikes the ground.

### FIELD OF THE INVENTION

The present invention is directed to an improved horseshoe for dampening the shock of impact when a hoof strikes the ground, and in particular, it is directed to an impact absorbing composite hoof pad inserted between the horseshoe and hoof. The composite hoof pad includes a retainer member that is adhesive bonded to the horseshoe and fixed to the hoof, and a cushion member that is adhesive bonded to the horseshoe and coupled to the retainer member. The cushion member spans the toe area, quarter, and heel areas of the horseshoe, and it has lower shore hardness than the material used to make the retainer member. The softer cushion member supports and reduces pressure on the sole of the hoof when the sole flexes downward in response to each impact of the hoof on the ground, thereby eliminating a major cause of hoof lameness.

When a horse runs at 30 miles per hour, about 48.3 kilometers per hour, the concussive force generated on each hoof as it strikes the ground is about 2,600 psi (182.8 kg/cm²). In the past, various hoof pad devices of different sizes, shapes, and materials have been inserted between the hoof and horseshoe to protect the hoof from the shock of impact (concussive force) when the hoof strikes the ground. Such hoof pad devices of the past are manufactured from resilient materials such as rubber, leather, felt, plastic, and the like, and they are either nailed, bonded, or nailed and bonded to the hoof and shoe.

These earlier hoof pads are effective in that they are able to cushion the shock of impact. However, each time the hoof strikes the ground, the force of the impact causes the resilient hoof pad to distort or flex along the direction of the applied force. In other words, the hoof pad distorts with each hoof beat. Such repeated distortion in the hoof pad causes lateral and/or transverse movement between the horseshoe and hoof, and it generates shear along the connection that fastens the horseshoe to the hoof wall. For example, in a mechanical connection, where the horseshoe and hoof pad are fastened to the hoof wall with nails, the repeated shoe movement tends to bend the nail shank, and over time, the nail will shear off leaving part of the nail in the hoof wall. As more nails shear, the shoe will shift and cause damage to the hoof wall, and sections of the hoof wall are torn away when the shoe is ripped off by the force of impact. In a chemical connection, where the hoof pad is bonded to the horseshoe and to the hoof wall with an adhesive, the horseshoe may be ripped from the hoof without any prior warning such as the shoe misalignment associated with mechanical connections. In addition, the glued connections of the past do not allow the heel area to expand and move as needed.

Accordingly, there is a long felt need within the art to provide a hoof pad that includes a soft component that dampens the force of impact, eliminates pad distortion, allows the heel to move freely, and reduces pressure when the sole of the hoof flexes on impact; in combination with a hard component that provides a stable connection and minimizes shear effect on the nails.

### SUMMARY OF THE INVENTION

Accordingly, it is a first object of the present invention to provide a composite hoof pad that cushions the shock of impact and minimizes shear when the hoof strikes the ground.

It is another object of the present invention to provide a composite hoof pad that minimizes shoe movement and thereby provides improved stability when the horse pushes off from the toe area of the composite hoof pad.

It is a further object of the present invention to provide a composite hoof pad with a retainer member that is fastened to a hoof and shaped to couple to and clasp the cushion member so that the clasped cushion member maintains dimensional stability when the hoof strikes the ground

It is another object of the present invention to provide a composite hoof pad wherein retainer member is adapted to transfer concussive forces into the coupled and clasped cushion member.

It is still another object of the present invention to provide a composite hoof pad where the cushion member has lower shore hardness on a durometer scale than the shore hardness of the retainer member fastened to the hoof.

It is yet another object of the present invention to provide a composite hoof pad that includes a retainer member fastened to a hoof and coupled to the cushion member with a half-lap joint.

In satisfaction of the foregoing objects and advantages, the present invention includes a horseshoe in combination with a composite hoof pad whereby the horseshoe comprises a lateral side, a medial side, a bottom surface, and a top surface that is defined by a toe area, a first quarter area and a second quarter area along opposite sides of the top surface, and a first heel area and a second heel area along said opposite sides of the top surface, and whereby the composite hoof pad includes a retainer member and a cushion member, the retainer member adhesive bonded to the top surface of the horseshoe, adapted for attachment to a hoof, and shaped to receive and capture the cushion member within a coupling provided therein, the cushion member is adhesive bonded to the top surface of the horseshoe, adhesive bonded within the retainer member coupling, and shaped to span the toe, quarter and heel areas of the horseshoe.

### BRIEF DESCRIPTION OF THE DRAWINGS

FIG. 1 is a schematic view showing the plantar surface of a horse hoof.

FIG. 2 is a cross-section view showing a prior art hoof pad fastened to a hoof.

FIG. 3 is a cross-section view similar to FIG. 2 showing the prior art hoof pad striking the ground.

FIG. 4 is an isometric view of the preferred embodiment of the present invention with one-half of the composite hoof pad removed.

FIG. 5 is a plan view showing the retainer member of the preferred embodiment.

FIG. 6 is a plan view showing the cushion member of the preferred embodiment.

FIG. 7 is a plan view of the preferred embodiment of the present invention with one-half of the composite hoof pad removed.

FIG. 8 is a plan view showing the entire retainer member and coupled cushion member.

FIG. 9 is a cross-section view showing the hoof pad of the present invention fastened to a hoof.

FIG. 10 is a cross-section view similar to FIG. 9 showing the hoof pad of the present invention striking the ground.

FIG. 11 is a view similar to FIG. 1 showing the preferred embodiment of the present invention fastened a horse hoof.

FIG. 12 is a view similar to FIG. 11 showing an alternate embodiment of the present invention fastened to a horse hoof.

FIG. 13A is a partial isometric view showing an alternate embodiment where the retainer member is integral with the horseshoe.

FIG. 13B is a partial isometric view showing a cushion member coupled to the horseshoe of FIG. 13A.

FIG. 14 is a partial isometric view showing an alternate coupling embodiment of the present invention.

FIG. 15 is a cross-sectional isometric view showing a different alternate coupling embodiment of the present invention.

FIG. 16 is a cross-sectional isometric view showing an alternate embodiment of the present invention where the composite hoof pad is extruded.

### DETAILED DESCRIPTION OF THE INVENTION

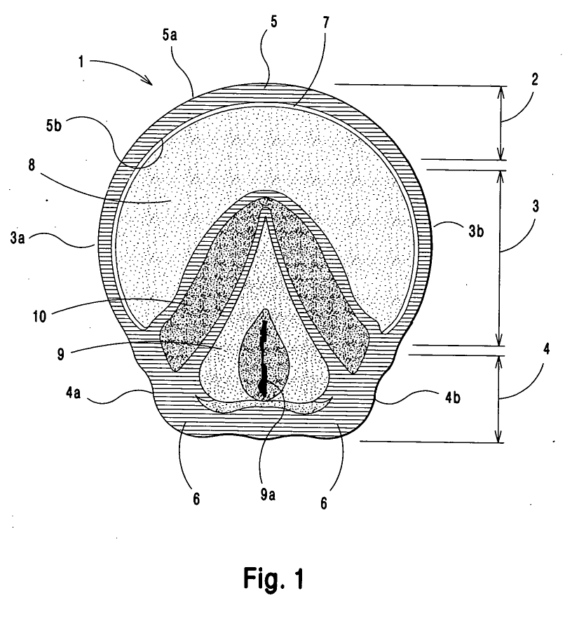

Referring to the drawing figures, FIG. 1 is a schematic representation showing the plantar surface of a horse hoof 1. The hoof of a horse comprises three broadly defined areas comprising the toe 2, the quarter 3, and the heel 4. The quarter and heel areas can be further defined by a right quarter and left quarter 3a and 3b respectively, and a right heel 4a and a left heel 4b. The right quarter 3a and right heel 4a are shown on the left side of the drawing figure because FIG. 1 is a bottom plan view of horse hoof 1. A hoof wall 5 extends along the toe 2 area and quarter areas 3a and 3b to a location proximate bulbs 6 that are located within the right and left heel areas 4a and 4b respectively. The hoof wall includes an anterior side 5a and a posterior side 5b adjacent a white line 7 that encircles sole 8 of the hoof. The hoof further includes a frog 9 having and median groove 9a positioned between bars 10.

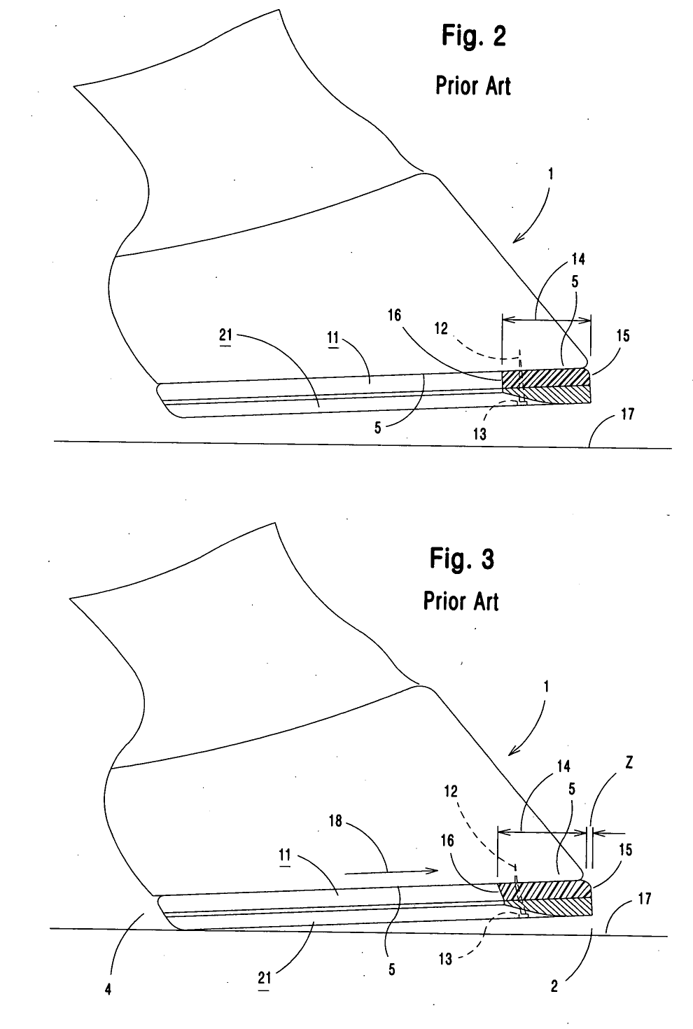

Referring to FIG. 2 and FIG. 3 labeled “Prior Art,” various impact absorbing hoof pads have been developed in the past to reduce the concussive force generated by the shock of impact when a horse hoof strikes the ground. For example, U.S. Pat. No. 6,497,293 B1 to Miller, U.S. Pat. No. 5,505,264 to Morris, et al., and U.S. Pat. Nos. 5,137,093 and 5,029,648 to Stephens show impact absorbing hoof pads made from various resilient materials. As heretofore mentioned above, such hoof pads are nailed, bonded, or both nailed and bonded to the hoof. In the prior art example shown in FIGS. 2 and 3, hoof pad 11 is attached to hoof 1 by driving nails 12 through holes 13 provided in the horseshoe 21. The top surface 14 of hoof pad 11 extends between an anterior side 15 and posterior side 16 of the hoof pad, and top surface 14 is positioned against the plantar surface of a horse hoof 1. Nails 12 are driven directly through hoof pad 11 and into the hoof wall 5 to fasten the horseshoe and hoof pad to the hoof.

Referring specifically to FIG. 2, hoof 1 is shown positioned above the ground 17 just before hoof 1 strikes the surface of the ground. When a horse moves at a fast gait, for example a trot, pace, gallop or run, the hoof rotates through a rapid complex movement called breakover. The term breakover refers hoof biometrics associated with the rotation of the hoof where the hoof heel strikes the ground first, then the entire plantar surface contacts the ground, and finally the toe lifts off the ground for the next stride. For example, referring to FIG. 3, when the rotating horse hoof 1 strikes the ground 17, the heel 4 normally impacts the ground slightly before the toe 2 makes contact. Such “heel first” contact causes shear in an outward direction as shown by arrow 18 and force is transmitted to the nailed and/or bonded connections that fasten the horseshoe 21 and hoof pad 11 to hoof 1. On impact with the ground 17, the outward shear force 18 causes hoof pad 11 to distort or elongate a distance “Z” depending on the amount of the applied force and the elasticity of the hoof pad material. In a mechanical connection, where the horseshoe 21 and hoof pad 11 are fastened to the hoof wall 5 with nails 12, the repeated shear and pad distortion “Z” tends to bend the nail shanks, as shown in FIG. 3. Such lateral and/or transverse distortions of the hoof pad causes shoe movement or wobble and the horseshoe becomes misaligned with the hoof 1. Over time, the continuous stress can shear the nailed connections and rip the horseshoe from the hoof. In a chemical connection, where the hoof pad 11 is bonded to both the horseshoe 21 and to the hoof wall 5 with an adhesive, the horseshoe is suddenly sheared from the hoof without any prior warning as indicated by the shoe misalignment in a nailed connection.

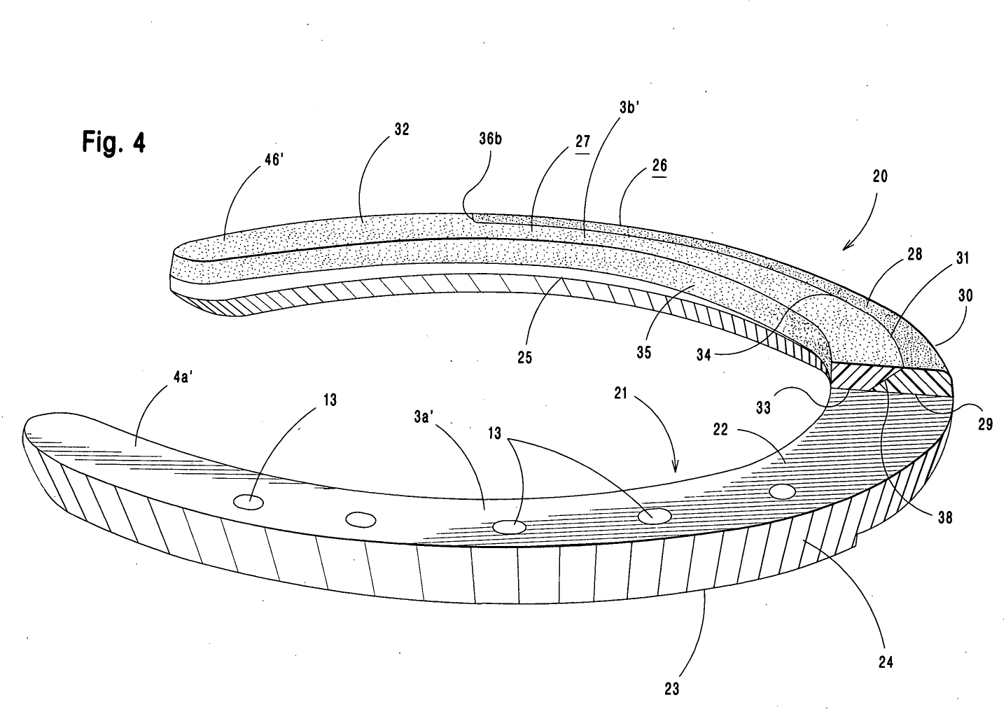

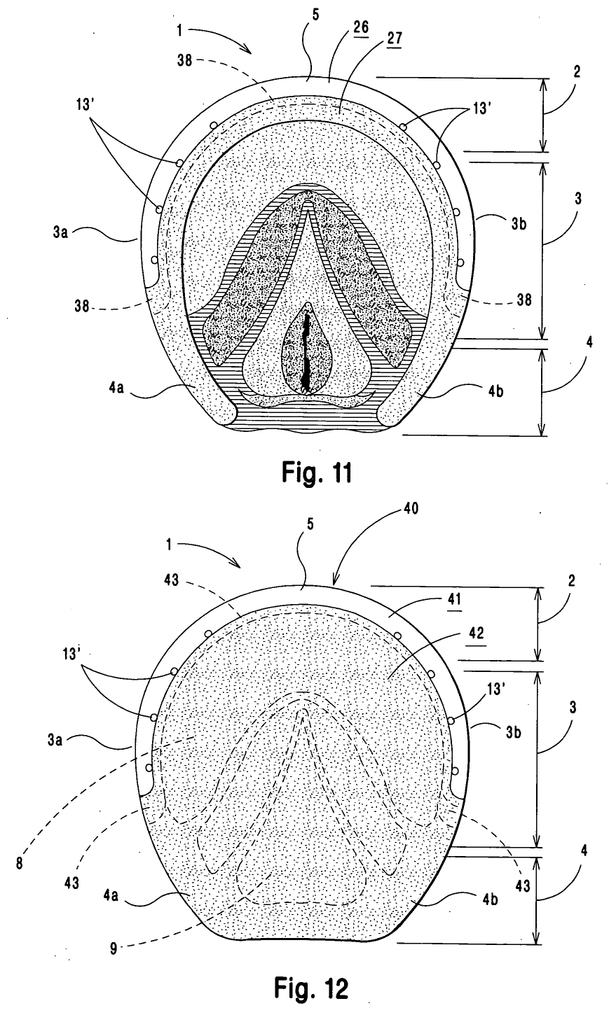

Referring to FIGS. 4 through 8 showing a hoof pad referred to in the art as a rim pad, the preferred embodiment of the present invention includes a composite hoof pad 20 positioned between a horseshoe 21 and the plantar surface of a horse hoof 1 (FIGS. 10 and 11). Horseshoe 21 includes a top surface 22 normally placed against the plantar surface of the hoof when a hoof pad is not used, or as in the present invention, against the composite hoof pad 20 positioned between the horseshoe 21 and the hoof. Horseshoe 21 further includes a bottom surface 23 that contacts the ground, a shoe anterior side 24, and a shoe posterior side 25. The top surface 22 is shaped to provide toe 2′, a quarter 3′, and a heel 4′ areas that correspond with the toe, quarter, and heel areas of the hoof shown in FIG. 1, including a right quarter and left quarter 3a′ and 3b′ respectively, and a right heel 4a′ and a left heel 4b′.

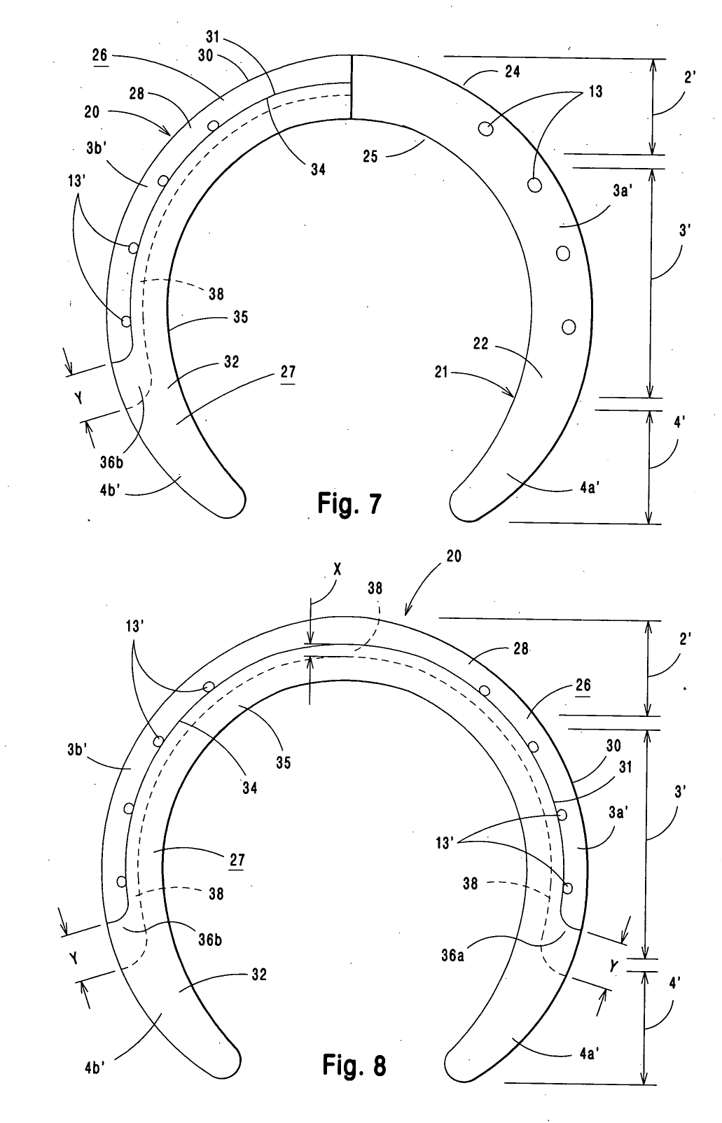

The composite hoof pad 20 also comprises toe, quarter, corresponding heel areas 2′, 3′, and 4′ that correspond with the like horseshoe areas, and the composite hoof pad includes a retainer member 26 and a cushion member 27. The retainer and cushion members are molded or extruded separately from different materials, as shown in FIGS. 6 and 7, and then bonded together with an adhesive and to the top surface 22 of the horseshoe to provide a completed composite hoof pad 20 positioned between the horseshoe and hoof. In the preferred embodiment, retainer member 26 is manufactured from a rubber, plastic or other similar material having a shore hardness greater than 80 shore on a durometer scale with a preferred hardness of between about 85-95 shore. The cushion member is manufactured from gum rubber or the like and it has a hardness of 70 shore and lower with a preferred hardness range between about 60 to about 65 shore.

The retainer member 26 (FIGS. 4-5 and 7-8) includes a top surface 28, bottom surface 29, an anterior side 30, and a posterior side 31 that is shaped to couple to cushion member 27. The posterior side also includes elongated opposed terminus end portions 36a and 36b that extend a length “Y” into the heel areas 4a′ and 4b′ of composite hoof pad 20 when coupled to the cushion member. In the preferred embodiment, length “Y” measures between about 0.5 to about 0.625 inches. This provides a long fade or transition between the harder retainer material and the softer cushion material, the long fade extending from the quarter area 3′ into the heel area 4′ of the composite hoof pad 20.

Similarly, cushion member 27 (FIGS. 4 and 6-8) has a top surface 32, bottom surface 33, a posterior side 35, and an anterior side 34. The anterior side 34 includes a shaped portion 37 that corresponds with, and couples to, the shaped posterior side 31 of the retainer member, including the terminus end portions 36a and 36b that extend into the heel areas 4a′ and 4b′ of composite hoof pad. Referring to FIG. 4, the coupled posterior side 31, and anterior side 34 comprise a mitered joint 38 connection. The mitered joint extends in a posterior downward direction from the retainer member top surface 28 to its bottom surface 29 so that mitered retainer member 26 extends under and supports a portion of the cushion member 27. As shown in FIG. 8, mitered joint length “X” at toe area 2′ is smaller than mitered joint length “Y” at the terminus end portions 36a and 36b.

During use, concussive forces are transferred from the horseshoe into the composite hoof pad 20. The shock absorbing material used for cushion member 27 dampens the impact of forces received from the horseshoe while the harder retainer member 26 transfers such incoming concussive forces into the softer cushion member through the mitered joint connection 38. The transfer of forces from the retainer member 26 into the cushion member 27 takes place along the mitered surface of the retainer member that extends beneath the cushion member along joint 38. In addition, the abutting surface of retainer member 26 along the mitered joint connection 38 prevents cushion member distortion as shown in FIG. 3 where the prior art hoof pad distorts a distance “Z” in response to the hoof striking the ground.

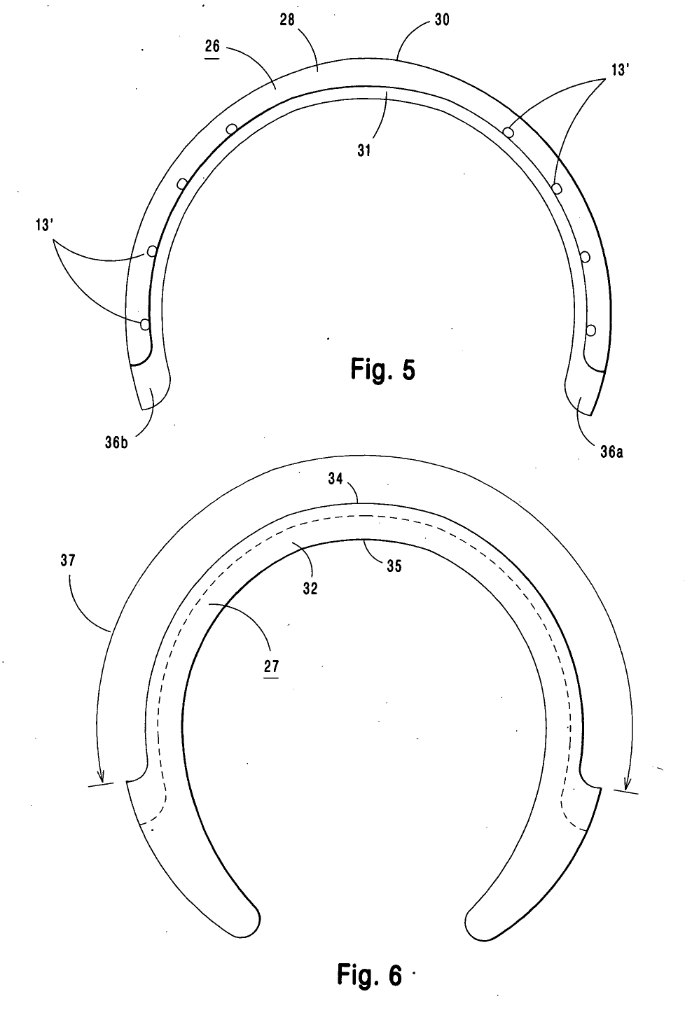

Horseshoes come in various shapes and sizes and the composite hoof pad of the present invention may be manufactured to fit any selected shoe configuration with the retainer member being shaped to coincide with the nail pattern of the selected horseshoe. Accordingly, FIGS. 7 and 8 shows a coupled composite hoof pad 20 of the present invention fixed to a selected horseshoe. The retainer member 26 and cushion member 27, shown separately in FIGS. 5 and 6, are coupled together along mitered joint 38 that extends from the retainer terminus end 36a, through the toe area 2, to terminus end 36b. Retainer member 26 is shaped to coincide with and to cover the nail pattern defined by spaced apart nail holes 13 extending through the horseshoe 21 (FIG. 7), and the retainer member 26 may include corresponding nail holes 13′ to facilitate nailing the combination horseshoe and hoof-pad to the hoof wall.

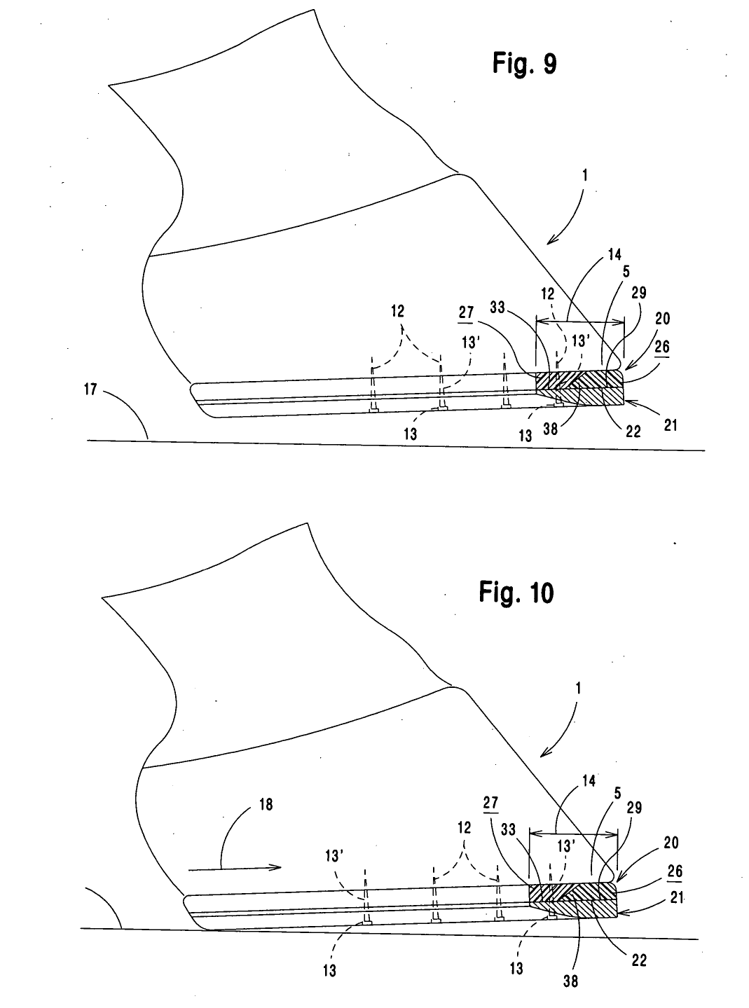

Referring to FIGS. 9, 10, and 11, showing the preferred composite hoof pad 20 positioned on a hoof, the horseshoe is removed in FIG. 11 for clarity, a first adhesive is applied to the top surface 22 of horseshoe 21 and to one half of mitered joint 38, either the retainer member half or the cushion member half. After the first applied adhesive is dry, a second adhesive is applied to the bottom surfaces 29 and 33 of the retainer member and cushion member respectively and to the remaining half of mitered joint 38, the half that did not receive the first applied adhesive. While the second adhesive is still wet, the adhesive coated bottom surfaces 29 and 33 are placed onto the dry first adhesive coated top surface 22 of the horseshoe and positioned so that the retainer and cushion members are coupled or interlocked along the adhesive coated mitered joint 38. After the adhesive bond is cured to its full strength, nails are inserted into the nail holes 13 and 13′ and they are driven into the hoof wall 5 that extends along the periphery of hoof 1 shown in FIGS. 1 and 11. In the present invention, the preferred first applied adhesive is a viscous liquid contact type cement and the preferred second applied adhesive is a cyanoacrylate adhesive. However, any suitable chemical bonding system known in the art may be used to couple and affix the composite hoof pad assembly 20 to the top surface 22 of horseshoe 21 without departing from the scope of the present invention.

Additionally, although the preferred embodiment shows nail holes 13′ extending through retainer member 26 to facilitate nailing the horseshoe and composite hoof pad to the hoof wall, FIG. 4 shows the retainer member 26 without nail holes. In such an arrangement, nails may be inserted into the nail holes 13 and the nails are driven through retainer member 26 into the hoof wall to mechanically attach the horseshoe and composite hoof pad retainer member to the hoof wall. Alternatively, in such a composite hoof pad assembly 20 without nail holes, the hoof pad may be chemically bonded to the horseshoe and hoof wall with a suitable adhesive, without nailing.

Referring again to FIGS. 9 and 10, the shaped or mitered portion 37 that extends along the anterior side 34 of cushion member 27 in FIG. 6, is captured within bounds defined by the retainer shaped posterior side 31 the planter surface of hoof 1, and the top surface 22 of the horseshoe 21. The harder and less resilient retainer member 26 that is fixed to the horseshoe and hoof wall provides a barrier that prevents the softer and more resilient cushion member 27 from distorting in response to the shock of impact when the hoof strikes the ground. Accordingly, the above mentioned problems associated with prior hoof pad arrangements, where the hoof pad distorts or stretches a distance “X” (FIG. 3) in response to the shock of impact, is eliminated. This reduces or eliminates shoe movement giving the horse greater stability when it pushes off on the harder retainer member that spans the toe area of the hoof. It also prevents nail break-off and thereby eliminates hoof wall damage associated with shoe loss, where sections of the hoof wall are torn away as the shoe is ripped from the hoof.

FIGS. 12, 13A, 13B, 14, and 15, show alternate embodiments of the present hoof pad invention. Referring now to FIG. 12, the alternate embodiment is a full pad 40 that covers the entire planter surface of hoof 1. The alternate composite hoof pad 40 is shown positioned on hoof 1 with the horseshoe removed for clarity. In the full pad embodiment, the physical properties and structural features are similar to the physical properties and structural features described above for the preferred retainer member 26 and the preferred cushion member 27. The full pad, cushion member 42 is coupled to retainer member 41 along joint 43, and cushion member 42 spans the right and left quarters 3a and 3b, and the right and left heels 4a and 4b respectively so that the sole 8 and frog 9 of the horse hoof are covered and protected by cushion member 42. Nail holes 13′ corresponding to the nail pattern may be provided in retainer member 41. The composite hoof pad members 41 and 42 are bonded to the horseshoe and to each other as described above, and the combination horseshoe and full composite hoof pad 40 may be either mechanically or chemically fastened to the hoof wall, or both.

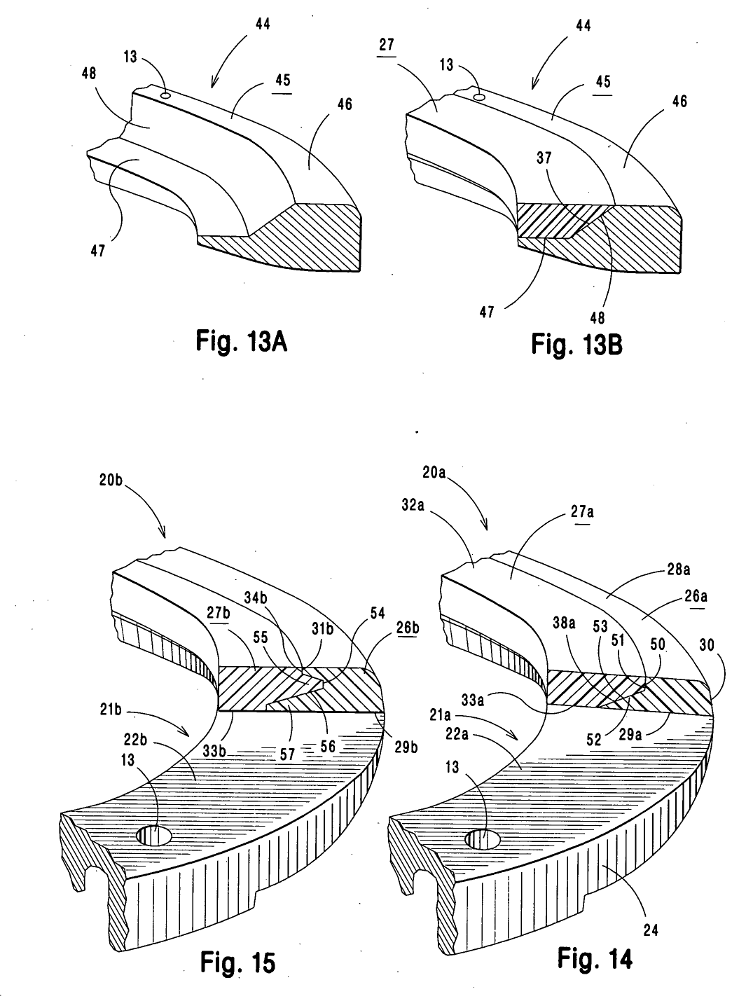

Referring to the alternate embodiment in FIGS. 13A and 13B, a metallic retainer member 45 is manufactured as an integral component of the horseshoe 44 to provide an in-situ retainer member 45 adapted to receive and couple to cushion member 27 (FIG. 6) or the like. Accordingly, horseshoe 44 includes a retainer top surface 46 positioned at an elevation above the horseshoe top surface 47, and the posterior side 48 of the in-situ retainer member 45 is shaped to couple to or interlock with the shaped portion 37 of the cushion member 27. The shaped portion of the in-situ retainer member 45 extends below and supports cushion member 27 to transfer concussive forces from the retainer member into the cushion member. Cushion member 27 is bonded to the horseshoe top surface 44 as heretofore described, and nail holes 13 extend through the retainer member portion of the horseshoe to fasten horseshoe 44 to a hoof wall. Alternatively, the horseshoe may be attached to the hoof wall by chemically bonding top surface 47 to the hoof wall, or by both mechanically fastening and chemically bonding top surface 47 to the hoof wall.

It should be understood that although the preferred embodiment shows a mitered joint connection 38 being used to couple the retainer and cushion members 26 and 27 of the composite impact pad 20, any suitable coupling arrangement may be used to interlock the retainer and cushion members without departing from the scope of the present invention. For example, referring to the alternate embodiment in FIG. 14, a half-lap joint 38a is used to couple the retainer member 26a and cushion member 27a of the composite impact pad 20a. The interlocking joint includes a vertical surface 50 that extends in a downward direction from retainer member top surface 28a and intersects inclined surface 52 that extends in a posterior downward direction to bottom surface 29a so that the inclined surface 52 extends under and supports a portion of the cushion member 27a. Retainer member is shaped to coincide with and cover the nail pattern provided by the spaced apart nail holes 13 that extend through horseshoe 21a. Cushion member 27a includes an inclined surface 53 that extends in both an upward and an anterior direction from the cushion member bottom surface 33a so that inclined surface 53 overlaps a portion of retainer member 26a and intersects vertical surface 51 extending downward from the cushion member top surface 32a. The interlocked lap joint 38a is fixed by adhesive bonding, and the bottom surfaces 29a and 33a are adhesive bonded to the top surface of a horseshoe 22a. When the composite hoof pad 20a is assembled, inclined surface 50 is positioned below inclined surface 51 so that the concussive forces generated by each hoof beat are transferred from the horseshoe 21a into retainer member 26a and into cushion member 27a through interlocked surfaces 50 and 51. In addition, because the harder retainer member 26a abuts the corresponding interlocked portion of the softer and more flexible cushion member 27a the retainer member prevents the cushion member from distorting in response to the shear forces generated by the shock of impact when the hoof strikes the ground.

FIG. 15 shows another alternate coupling mechanism embodiment used to interlock the retainer and cushion members 26b and 27b of composite hoof pad 20b. In this alternate embodiment, the retainer member coincides with, and covers the nail pattern defined by spaced apart nail holes 13 that extend through horseshoe 21b. Retainer member 26b is shaped to provide a groove 54 that extends along the posterior side 31b between terminal end portions similar to 36a and 36b of the retainer member shown in FIG. 8. Likewise, the anterior side 34b of cushion member 27b includes a tongue 55 that extends along a shaped portion similar to shaped portion 37 shown in FIG. 6. When coupled together, the posterior side 31b and anterior side 34b provide a tongue and groove joint 56. The interlocked tongue and groove joint 56 is chemically bonded a suitable adhesive, and the bottom surfaces 29b and 33b are chemically bonded with a suitable adhesive to the top surface 22b of a horseshoe 21b as heretofore described above. The retainer member portion of the coupled tongue and groove joint 56 includes an extended bottom leg 57 that extends under and supports a portion of the cushion member 27b so that the retainer member transfers concussive forces into the softer more resilient cushion member 27b when the horseshoe strikes the ground. FIGS. 14 and 15 are only two exemplary coupling arrangements that could be used to interlock the retainer and cushion members of the present composite hoof pad invention without departing from the scope of the present invention.

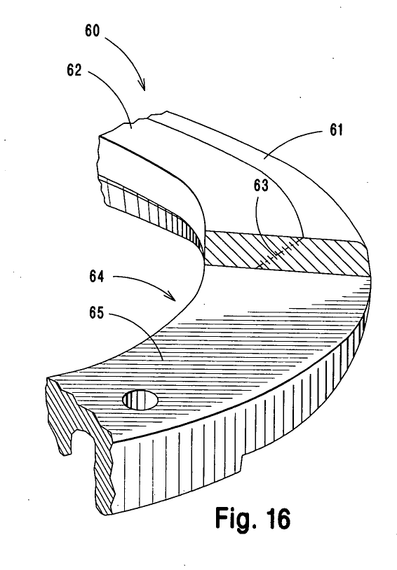

FIG. 16 shows a retainer member 61 extruded or molded with a cushion member 62 to provide a composite hoof pad 60. The retainer and cushion members are chemically or molecularly bonded together along a joint line 63 shaped similar to joint 38 shown in FIG. 8, and retainer member 61 is shaped to coincide with and cover the nail pattern in any given horseshoe 64 and composite hoof pad is chemically bonded to the top surface 65 of the horseshoe as described above. Joint 63 extends from the retainer member terminus end 36a through the toe 2 to terminus end 36b as shown in FIG. 8. The material used to extrude or mold retainer member 61 is harder than the cushion member material. Similar to the FIG. 8 joint, joint 63 extends the harder retainer member below cushion member 62 so that concussive forces generated by the impacting hoof are transferred from the horseshoe, into retainer member 61, and into cushion member 61 where the concussive force is dampened.

As such, the present invention has been disclosed in terms of preferred and alternate embodiments that fulfill each one of the objects set forth above, and the invention provides a new and improved hoof pad that reduces the shock of impact when a hoof strikes the ground, and eliminates hoof pad distortion that causes the horseshoe shear. Of course, those skilled in the art may contemplate various changes, modifications, and alterations from the teachings of the present disclosure without departing from the intended spirit and scope of the present invention.

I claim:

1. In a horseshoe attached to a hoof, the horseshoe including a bottom surface, a top surface, an anterior side, and a posterior side, wherein the horseshoe top surface includes a toe area, a first quarter area opposite a second quarter area, and a first heel area opposite a second heel area, the improvement comprising a composite hoof pad positioned between the horseshoe top surface and the hoof, said composite hoof pad including:
a) a retainer member having a retainer top surface, a retainer bottom surface fixed to the horseshoe top surface, a retainer anterior side positioned proximate the horseshoe anterior side, and a retainer posterior side, said retainer posterior side shaped to provide a retainer coupling member; and
b) a cushion member having a cushion top surface, a cushion bottom surface fixed to the horseshoe top surface, a cushion posterior side, and a cushion anterior side that includes a cushion coupling member fixed to said retainer coupling member to provide a coupled joint therebetween.

2. The invention recited in claim 1 wherein:
a) said retainer member is shaped to span a distance from a location within the first quarter area, through the toe area, and to a location within the second quarter area of the horseshoe top surface; and
b) said cushion member is shaped to span a distance that includes the first heel area through the second heel area including the first quarter area, the toe area, and the second quarter area of the horseshoe top surface.

3. The invention recited in claim 2 wherein said shaped retainer member coincides with a nail pattern in the horseshoe.

4. The invention recited in claim 1 wherein said fixed retainer bottom surface and said fixed cushion bottom surface are chemically bonded to the horseshoe top surface.

5. The invention recited in claim 4 wherein said chemical bond is an adhesive bond that includes a first adhesive applied to the horseshoe top surface and a second adhesive applied to said retainer bottom surface and applied to said cushion bottom surface.

6. The invention recited in claim 5 wherein said first applied adhesive is viscous liquid contact type cement and said second applied adhesive is a cyanoacrylate adhesive.

7. The invention recited in claim 5 wherein said retainer bottom surface and said cushion bottom surface are fixed to the horseshoe top surface when said first applied adhesive is dried and when said second applied adhesive is wet.

8. The invention recited in claim 4 wherein said chemical bond is an adhesive bond that includes a first adhesive applied to said retainer bottom surface and applied to said cushion bottom surface and a second adhesive applied to the horseshoe top surface.

9. The invention recited in claim 8 wherein said first applied adhesive is viscous liquid contact type cement and said second applied adhesive is a cyanoacrylate adhesive.

10. The invention recited in claim 8 wherein said retainer bottom surface and said cushion bottom surface are fixed to the horseshoe top surface when said first applied adhesive is dried and when said second applied adhesive is wet.

11. The invention recited in claim 1 wherein said retainer coupling member is chemically bonded to said cushion coupling member.

12. The invention recited in claim 11 wherein said chemical bond is an adhesive bond that includes a first adhesive applied to a first coupling member selected from said retainer coupling member and said cushion coupling member, and a second adhesive applied to a second coupling member selected from said retainer coupling member and said cushion coupling member.

13. The invention recited in claim 12 wherein said first applied adhesive is viscous liquid contact type cement and said second applied adhesive is a cyanoacrylate adhesive.

14. The invention recited in claim 12 wherein said coupled joint is interlocked when said first applied adhesive is dried and when said second applied adhesive is wet.

15. The invention recited in claim 1 wherein said retainer member is harder than said cushion member.

16. The invention recited in claim 15 wherein said retainer member has a hardness of about 80 shore and higher.

17. The invention recited in claim 15 wherein said retainer member has a hardness of between about 85 shore to about 90 shore.

18. The invention recited in claim 15 wherein said cushion member has a hardness of about 70 shore and lower.

19. The invention recited in claim 15 wherein said cushion member has a hardness of between about 60 shore to about 65 shore.

20. The invention recited in claim 1 wherein said retainer member extends beneath said cushion member along said coupled joint.

21. The invention recited in claim 20 wherein said coupled joint is a mitered joint.

22. The invention recited in claim 20 wherein said coupled joint is a half-lap joint.

23. The invention recited in claim 20 wherein said coupled joint is a tongue and groove joint.

24. The invention recited in claim 20 wherein said coupled joint is an extruded molecular joint.

25. A composite hoof pad for use between a horseshoe and hoof, said composite hoof pad including:
a) a retainer member having a retainer top surface, a retainer bottom surface, a retainer anterior side, and a retainer posterior side, said retainer member shaped to span a first quarter area, a toe area, into a second quarter area of a selected horseshoe, said retainer posterior side shaped to provide a retainer coupling member; and
b) a cushion member having a cushion top surface, a cushion bottom surface, a cushion anterior side, and a cushion posterior side, said cushion member shaped to span a distance along the selected horseshoe top surface that includes a first heel area, and the first quarter area, the toe area, the second quarter area, through a second heel area, said cushion anterior side including a cushion coupling member fixed to said retainer coupling member to provide a coupled joint therebetween.

26. The hoof pad recited in claim 25 wherein:
a) said retainer member is shaped to span a distance from a location within a first quarter area, through a toe area, and to a location within a second quarter area of a horseshoe top surface; and
b) said cushion member is shaped to span a distance that includes a first heel area through a second heel area including the first quarter area, the toe area, and the second quarter area of the horseshoe top surface.

27. The hoof pad recited in claim 26 wherein said shaped retainer member coincides with a nail pattern in said horseshoe.

28. The hoof pad recited in claim 25 wherein said retainer coupling member is chemically bonded to said cushion coupling member.

29. The hoof pad recited in claim 28 wherein said chemical bond is an adhesive bond that includes a first adhesive applied to a first coupling member selected from said retainer coupling member and said cushion coupling member, and a second adhesive applied to a second coupling member selected from said retainer coupling member and said cushion coupling member.

30. The hoof pad recited in claim 29 wherein said first applied adhesive is viscous liquid contact type cement and said second applied adhesive is a cyanoacrylate adhesive.

31. The hoof pad recited in claim 29 wherein said coupled joint is interlocked when said first applied adhesive is dried and when said second applied adhesive is wet.

32. The hoof pad recited in claim 25 wherein said retainer member is harder than said cushion member.

33. The hoof pad recited in claim 32 wherein said retainer member has a hardness of about 80 shore and higher.

34. The hoof pad recited in claim 32 wherein said retainer member has a hardness of between about 85 shore to about 90 shore.

35. The hoof pad recited in claim 32 wherein said cushion member has a hardness of about 70 shore and lower.

36. The hoof pad recited in claim 32 wherein said cushion member has a hardness of between about 60 shore to about 65 shore.

37. The hoof pad recited in claim 25 wherein said retainer member extends beneath said cushion member along said coupled joint.

38. The hoof pad recited in claim 37 wherein said coupled joint is a mitered joint.

39. The hoof pad recited in claim 37 wherein said coupled joint is a half-lap joint.

40. The hoof pad recited in claim 37 wherein said coupled joint is a tongue and groove joint.

41. The hoof pad recited in claim 37 wherein said coupled joint is an extruded molecular joint.

42. An impact absorbing horseshoe, comprising:
a) an improved top surface including;
i. toe area, a first quarter area opposite a second quarter area, and a first heel area opposite a second heel area; and
ii. an integral retainer member the extends in an upward direction from said improved top surface, said integral retainer member said integral retainer member including a posterior side shaped to provide a retainer coupling member; and
b) a cushion member fixed to said improved top surface, said cushion member having an anterior side that includes a cushion coupling member fixed to said retainer coupling member to provide a coupled joint therebetween.

43. The impact absorbing horseshoe recited in claim 42 wherein
a) said retainer member is shaped to span a distance along improved top surface from inside said first quarter area, said toe area, into said second quarter area; and
b) said cushion member shaped to span a distance along said improved top surface that includes said first heel area, said first quarter area, said toe area, said second quarter area, and through said second heel area.

44. The impact absorbing horseshoe recited in claim 43 wherein said shaped retainer member coincides with a nail pattern in said impact absorbing horseshoe.

45. The impact absorbing horseshoe recited in claim 42 wherein said fixed cushion member includes a bottom surface chemically bonded to said improved top surface.

46. The impact absorbing horseshoe recited in claim 45 wherein said chemical bond is an adhesive bond that includes a first adhesive applied to said improved top surface and a second adhesive applied to said cushion member bottom surface.

47. The impact absorbing horseshoe recited in claim 46 wherein said first applied adhesive is viscous liquid contact type cement and said second applied adhesive is a cyanoacrylate adhesive.

48. The impact absorbing horseshoe recited in claim 46 wherein said cushion member bottom surface is fixed to said improved top surface when said first applied adhesive is dried and when said second applied adhesive is wet.

49. The impact absorbing horseshoe recited in claim 45 wherein said chemical bond is an adhesive bond that includes a first adhesive applied to said cushion member bottom surface and a second adhesive applied to said improved top surface.

50. The impact absorbing horseshoe recited in claim 49 wherein said first applied adhesive is viscous liquid contact type cement and said second applied adhesive is a cyanoacrylate adhesive.

51. The impact absorbing horseshoe recited in claim 49 wherein said cushion member bottom surface is fixed to said improved top surface when said first applied adhesive is dried and when said second applied adhesive is wet.

52. The impact absorbing horseshoe recited in claim 42 wherein said retainer coupling member is chemically bonded to said cushion coupling member.

53. The impact absorbing horseshoe recited in claim 52 wherein said chemical bond is an adhesive bond that includes a first adhesive applied to a first coupling member selected from said retainer coupling member and said cushion coupling member, and a second adhesive applied to a second coupling member selected from said retainer coupling member and said cushion coupling member.

54. The impact absorbing horseshoe recited in claim 53 wherein said first applied adhesive is viscous liquid contact type cement and said second applied adhesive is a cyanoacrylate adhesive.

55. The impact absorbing horseshoe recited in claim 53 wherein said coupled joint is interlocked when said first applied adhesive is dried and when said second applied adhesive is wet.

56. The impact absorbing horseshoe recited in claim 42 wherein said retainer member is harder than said cushion member.

57. The impact absorbing horseshoe recited in claim 56 wherein said retainer member has a hardness of about 80 shore and higher.

58. The impact absorbing horseshoe recited in claim 56 wherein said retainer member has a hardness of between about 85 shore to about 90 shore.

59. The impact absorbing horseshoe recited in claim 56 wherein said cushion member has a hardness of about 70 shore and lower.

60. The impact absorbing horseshoe recited in claim 56 wherein said cushion member has a hardness of between about 60 shore to about 65 shore.

61. The impact absorbing horseshoe recited in claim 42 wherein said integral retainer member extends beneath said cushion member along said coupled joint.

62. The impact absorbing horseshoe recited in claim 61 wherein said coupled joint is a mitered joint.

63. The impact absorbing horseshoe recited in claim 61 wherein said coupled joint is a half-lap joint.

64. The impact absorbing horseshoe recited in claim 61 wherein said coupled joint is a tongue and groove joint.

65. The impact absorbing horseshoe recited in claim 61 wherein said coupled joint is an extruded molecular joint.

66. An impact absorbing hoof pad comprising a ridged retainer member fixed to a flexible cushion member along a coupled joint where said ridged retainer member extends beneath said cushion member along said coupled joint so that concussive forces are transferred from an attached horseshoe through the extended portion of said ridged retainer member and into said cushion member when said attached horseshoe impacts on a surface.

67. The impact absorbing hoof pad recited in claim 66 wherein a length of said ridged retainer member extended portion is greater in a heel area of said attached horseshoe than a corresponding length of said ridged retainer member extended portion in a toe area of said attached horseshoe.

68. The impact absorbing hoof pad recited in claim 66 wherein said coupled joint is chemically bonded.

69. The impact absorbing hoof pad recited in claim 66 wherein said ridged retainer member has a hardness between about 85 shore to about 90 shore and said flexible cushion member has a hardness between about 60 shore to about 65 shore.
